(19) United States
(12) Patent Application Publication
(10) Pub. No.: US 2015/0103016 A1
(43) Pub. Date: Apr. 16, 2015

(54) ELECTRONIC DEVICES AND METHOD FOR NEAR FIELD COMMUNICATION BETWEEN TWO ELECTRONIC DEVICES

(71) Applicant: MediaTek, Inc., Hsin-Chu (TW)

(72) Inventor: Hao-Jung LI, Zhubei City (TW)

(73) Assignee: MediaTek, Inc., Hsin-Chu (TW)

(21) Appl. No.: 14/242,006

(22) Filed: Apr. 1, 2014

Related U.S. Application Data
(60) Provisional application No. 61/889,575, filed on Oct. 11, 2013.
(60) Provisional application No. 61/898,604, filed on Nov. 1, 2013.

(51) Int. Cl. G06F 3/041

(52) U.S. Cl. CPC G06F 3/041
USPC 345/173

(57) ABSTRACT

An electronic device includes a touch screen, a proximity sensor and a processor. The touch screen includes transmitting electrodes and receiving electrodes configured for sensing touch events on the touch screen. The proximity sensor is configured for sensing approach of an external object. The processor is coupled to the touch screen and the proximity sensor. When the proximity sensor senses a distance to the external object is under a predetermined threshold, the processor generates a request, transmits the request to the external object via the transmitting electrodes, receives a response from the external object via the receiving electrodes, and performs an action after receiving the response.

### CROSS REFERENCE TO RELATED APPLICATIONS

This application claims the benefit of U.S. Provisional Application No. 61/889,575 filed 2013 Oct. 11 and entitled “Near Field Communication System”, and U.S. Provisional Application No. 61/898,604 filed 2013 Nov. 1 and entitled “Near Field Communication System”. The entire contents of which are hereby incorporated by reference.

### BACKGROUND OF THE INVENTION

1. Field of the Invention

The invention relates to a system and method for near field communication between two electronic devices.

2. Description of the Related Art

In the field of computing, a user may be required to input confidential information on a system or request some information from the system for different reasons. In one example, the user may be required to type in a username and password when initially logging into a computer or computer network. In another example, the user may have to manually provide a username and password when logging into certain websites on the system. In yet another example, the user may be required to provide credit card information when shopping online on the system. In yet another example, the user may input some request to try to receive interested data or information from the system

In the above examples, the inputting of authentication information or request can be inconvenient for the user and insecure for the system. Thus, it is worth developing devices and methods that are beneficial to lessen the burden on the user and increase system security.

### BRIEF SUMMARY OF THE INVENTION

Electronic devices and methods for near field communication between two electronic devices are provided. An exemplary embodiment of an electronic device comprises a touch screen, a proximity sensor and a processor. The touch screen comprises a plurality of transmitting electrodes and a plurality of receiving electrodes configured for sensing touch events on the touch screen. The proximity sensor is configured for sensing approach of an external object. The processor is coupled to the touch screen and the proximity sensor. When the proximity sensor senses that a distance to the external object is under a predetermined threshold, the processor generates a request, transmits the request to the external object via the transmitting electrodes, receives a response from the external object via the receiving electrodes, and performs an action after receiving the response.

An exemplary embodiment of a near field communication method for using an electronic device comprises: generating a request when sensing a distance to an external object is under a predetermined threshold; transmitting the request via a plurality of transmitting electrodes of the electronic device to the external object; receiving a response from the external object via a plurality of receiving electrodes of the electronic device; and performing an action after receiving the response.

An exemplary embodiment of a dongle device comprises a plurality of transmitting electrodes, a plurality of receiving electrodes and a processor configured for checking whether a key for near field communication exists, generating a request when the key for near field communication exists, transmitting the request to a first electronic device via the transmitting electrodes, and receiving a response from the first electronic device via the receiving electrodes.

An exemplary embodiment of an electronic device comprises a transparent panel and a processor. The transparent panel comprises a plurality of transmitting electrodes. The processor is configured for transmitting a plurality of advertisement messages via the transmitting electrodes.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary block diagram of an electronic device according to an embodiment of the invention;

FIG. 2 is a schematic diagram showing a near field communication system according to an embodiment of the invention;

FIG. 3 shows an exemplary electrode grid of a touch screen according to an embodiment of the invention;

FIG. 4 shows an exemplary flow chart of a method for near field communication between two electronic devices from the perspective of an electronic device initiating the handshake procedure according to an embodiment of the invention;

FIG. 5 shows another exemplary flow chart of a method for near field communication between two electronic devices from the perspective of an electronic device joining the handshake procedure according to another embodiment of the invention;

FIG. 6 shows an exemplary timing diagram of video/audio data according to an embodiment of the invention;

FIG. 7 shows an exemplary block diagram of another electronic device according to another embodiment of the invention;

FIG. 8 is a schematic diagram showing a near field communication system according to another embodiment of the invention;

FIG. 9 shows an exemplary block diagram of another electronic device according to yet another embodiment of the invention; and

FIG. 10 is a schematic diagram showing a near field communication system according to yet another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

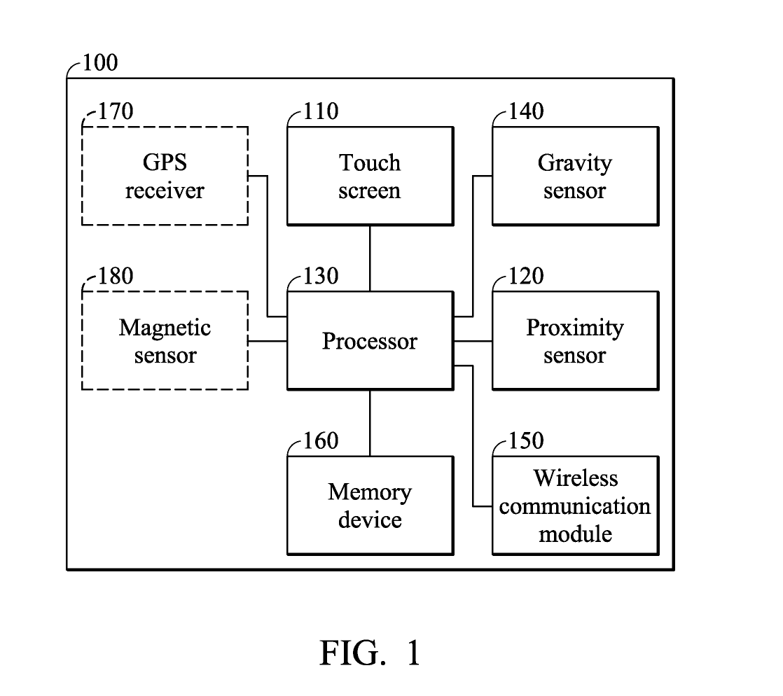

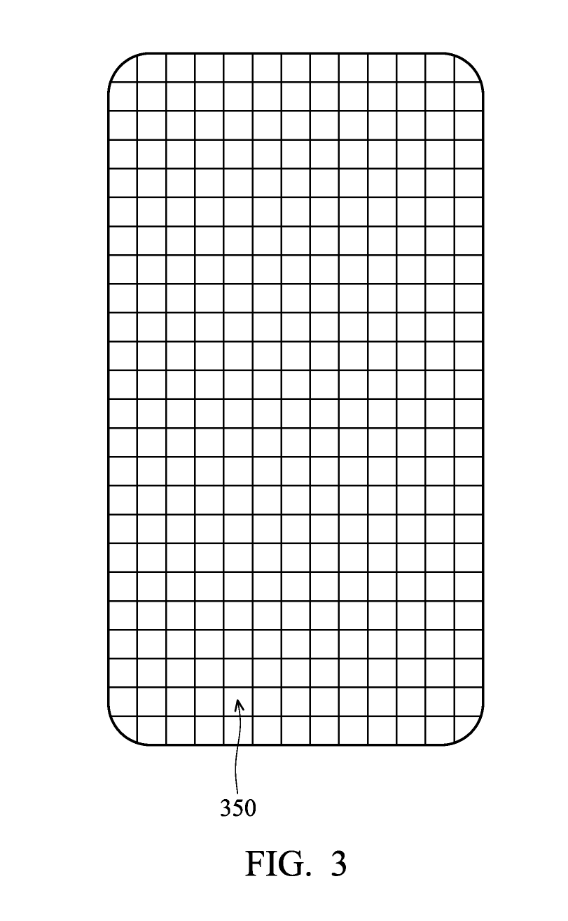

FIG. 1 shows an exemplary block diagram of an electronic device according to an embodiment of the invention. The electronic device 100 may at least comprise a touch screen 110, a proximity sensor 120, a processor 130, a gravity sensor 140, a wireless communication module 150 and a memory device 160. The touch screen 110 may comprise an electrode grid (such as the electrode grid 350 shown in FIG. 3) formed by a plurality of transmitting electrodes and a plurality of receiving electrodes configured for sensing touch events on the touch screen 110. The proximity sensor 120 is configured for sensing approach of an external object and a distance from the external object to the electronic device 100. The processor 130 may be a central processing unit (CPU) coupled to the proximity sensor 120, the gravity sensor 140, the wireless communication module 150 and the memory device 160, and control the operations thereof. The gravity sensor 140 is configured for sensing and collecting gravity variation of the electronic device 100. The wireless communication module 150 may at least comprise one or more antennas (not shown), a radio transceiver (not shown), and a baseband signal processing device (not shown), and is configured for providing wireless communication services. The memory device 160 may be any type of memory and is configured for storing system and user data.

In some embodiment of the invention, the electronic device 100 may further comprise a global positioning system (GPS) receiver 170 and a magnetic sensor 180. The GPS receiver 170 is configured for receiving GPS signals for positioning the location of the electronic device 100. The magnetic sensor 180 is configured for sensing and collecting magnetic field variation of the electronic device 100.

According to an embodiment of the invention, when the proximity sensor 120 senses that the distance to the external object is under a predetermined threshold (for example, 5 cm), the processor 130 may generate a request, transmit the request to the external object via the transmitting electrodes of the touch screen 110, receive a response from the external object via the receiving electrodes of the touch screen 110, and perform an action after receiving the response (which will be further discussed in the following paragraph).

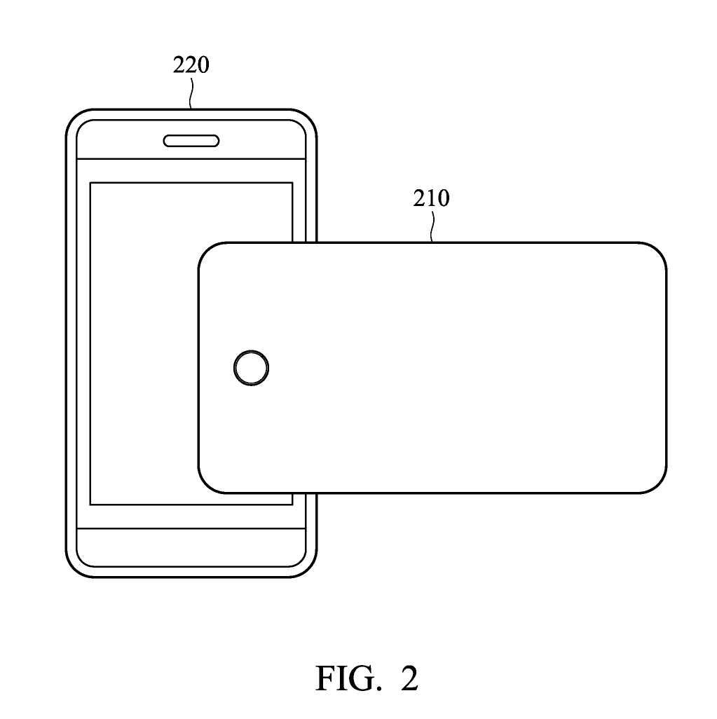

FIG. 2 is a schematic diagram showing a near field communication system according to an embodiment of the invention. The near field communication system may at least comprise two electronic devices 210 and 220. The electronic devices 210 and 220 may be the electronic device 100 as shown in FIG. 1. According to an embodiment of the invention, the electronic device 210 may first check whether a key for near field communication exists (and/or matches a predetermined value). When the key exists (and/or matches a predetermined value) and when the proximity sensor (e.g. the proximity sensor 120) of the electronic device 210 senses the distance to the external object (for example, the electronic device 220) is under a predetermined threshold, it means that the electronic device 220 approaches the electronic device 210, and the electronic device 210 is allowed to establish a near field communication with the electronic device 220 (since the key exists and/or matches a predetermined value). Therefore, the processor (e.g. the processor 130) of the electronic device 210 may generate a request and transmit the request to the electronic device 220 via the transmitting electrodes of the touch screen (e.g. the touch screen 110) of the electronic device 210.

According to an embodiment of the invention, the processor (e.g. the processor 130) of the electronic device 210 transmits the request to the electronic device 220 to initiate a handshake procedure. Because the electronic device 220 is brought into physical proximity with the electronic device 210, the electromagnetic fields associated with the electrode grids within the two touch screens of the electronic devices 210 and 220 may interact. Therefore, the electronic device 220 may receive the request from the electronic device 210 via the receiving electrodes of the touch screen (e.g. the touch screen 110) of the electronic device 220. After receiving the request, the processor (e.g. the processor 130) of the electronic device 220 may check whether a key for near field communication exists (and/or matches a predetermined value). Note that in some embodiments of the invention, the processor of the electronic device 220 may also optionally play a notify sound or trigger a vibration so as to notify the user that a request from another electronic device has been received. When the key exists (and/or matches a predetermined value), the processor of the electronic device 220 may generate a response for responding to the request, and transmit the response to the electronic device 210 via the transmitting electrodes of the touch screen (e.g. the touch screen 110) of the electronic device 220, so as to participate in the handshake procedure. In the handshake procedure, the electronic device 210 and the electronic device 220 may exchange essential information for establishing a wireless communication link therebetween. For example, the essential information may be a communication address and/or corresponding protocol setting values thereof, such as a WiFi address, a Bluetooth address, a username, a password, or others.

Next, the processor of the electronic device 210 may further receive the response via the receiving electrodes thereof, and may further transmit any messages to the electronic device 220 via the transmitting electrodes thereof when required, so as to complete the handshake procedure. According to an embodiment of the invention, the electronic device 210 and the electronic device 220 may further exchange essential information for performing a subsequent action in the handshake procedure. The essential information may vary with the different actions. When the handshake procedure is completed, the wireless communication link may further be established between the electronic device 210 and the electronic device 220 by the wireless communication module (e.g. the wireless communication module 150) thereof, and the electronic device 210 and/or the electronic device 220 may perform the action. According to an embodiment of the invention, the electronic device 210 may interact with the electronic device 220 via the wireless communication link established therebetween when performing the action.

In the embodiments of the invention, the action may be flexibly designed. For example, the action may be waking up the operating system of the electronic device, playing audio signals, playing video signals, turning on a camera, turning on an application program, performing a transaction, transmitting data (such as a file, a picture, a video, a song, or the like) to another electronic device, or others. Note that in the embodiments of the invention, the action is not necessary to be performed right after the handshake procedure. For example, the action may be performed at a preset time, even when the two electronic devices 210 and 220 are no longer close to each other.

In addition, in the embodiments of the invention, to enhance the security of performing the action, the processor (e.g. the processor 130) may first check the key for near field communication exists (and/or matches a predetermined value) before initiating or joining the handshake procedure. According to an embodiment of the invention, the key may also be flexibly designed as a software, firmware, and/or hardware value or condition, or any combination thereof. For example, the key may be an eFuse of the CPU, the hardware information of the electronic device, a file stored in the memory device 160, a gesture input by the user, the navigation or location information obtained by the GPS receiver 170, a gravity variation or magnetic field variation sensed by the gravity sensor 140 or the magnetic sensor 180, or others.

Note that in some embodiments of the invention, the processor may check more than one key for further enhancement of the security, and the invention should not be limited thereto. Note further that the key and action illustrated above are merely some examples of a variety of possible implementations, and the invention should not be limited thereto.

According to an embodiment of the invention, the proximity sensor (e.g. the proximity sensor 120) of the electronic device 210 may keep sensing the distance to the electronic device 220 during the handshake procedure. Once the distance to the electronic device 220 is not under the predetermined threshold, the processor of the electronic device 210 may stop or terminate the handshake procedure. Note that the proximity sensor (e.g. the proximity sensor 120) of the electronic device 220 may also sense the distance to the electronic device 210 during the handshake procedure for one or more times, and the invention should not be limited thereto. Once the distance to the electronic device 210 is not under the predetermined threshold, the processor of the electronic device 220 may also stop or terminate the handshake procedure.

According to another embodiment of the invention, the gravity sensor 140 of either electronic device may also participate in the handshake procedure and/or the action. The gravity sensor 140 may transmit information regarding the gravity variation to the processor 130 to facilitate the processor performing the handshake procedure and/or the action. For example, when two electronic devices 210 and 220 are so close to each other as shown in FIG. 2, the screens of the two electronic devices 210 and 220 may be blocked and the user may be unable to see what is shown on the screen and may also be unable to input any command via the touch screen. Therefore, instead of inputting the command via the touch screen, the user may input the command via moving or shaking the electronic device. Once the gravity sensor 140 senses the gravity variation, information regarding the gravity variation can be transmitted to the processor 130 to facilitate the processor performing the handshake procedure and/or the action. For example, the command input by the user by moving or shaking the electronic device may be, but is not limited to, sending an “OK” response to the processor to indicate that the user approves of the following action.

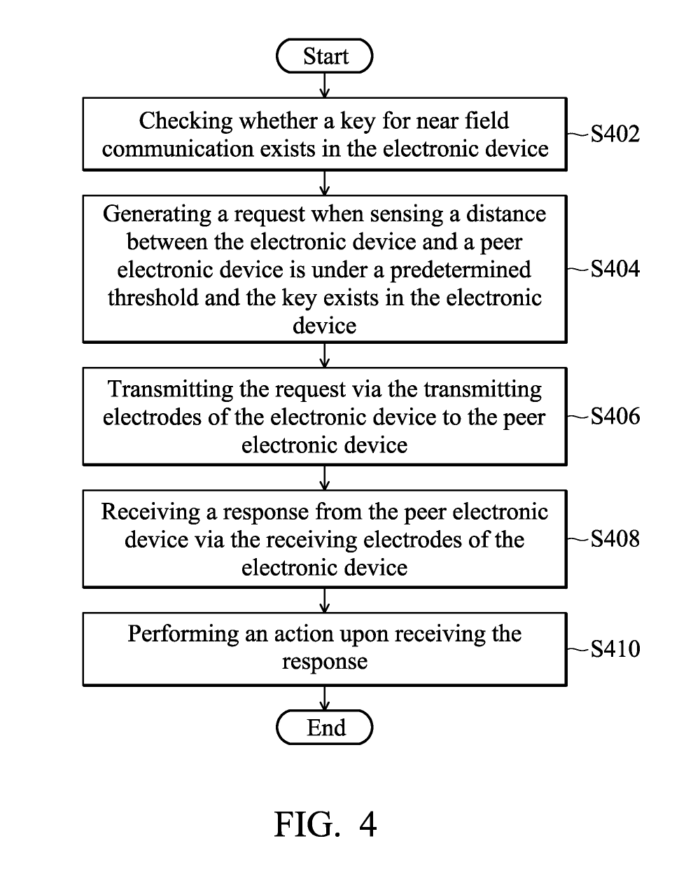

FIG. 4 shows an exemplary flow chart of a method for near field communication between two electronic devices, from the perspective of an electronic device initiating the handshake procedure, according to an embodiment of the invention. First of all, the electronic device may check whether a key for near field communication exists (Step S402). Next, the electronic device may generate a request when sensing a distance between the electronic device and a peer electronic device is under a predetermined threshold and the key exists (Step S404). Next, the electronic device may transmit the request via the transmitting electrodes of the electronic device to the peer electronic device (Step S406). Next, the electronic device may receive a response from the peer electronic device via the receiving electrodes of the electronic device (Step S408). Finally, the electronic device may perform an action after receiving the response (Step S410). Note that the peer electronic device may be regarded as an external object external to the electronic device initiating the handshake procedure.

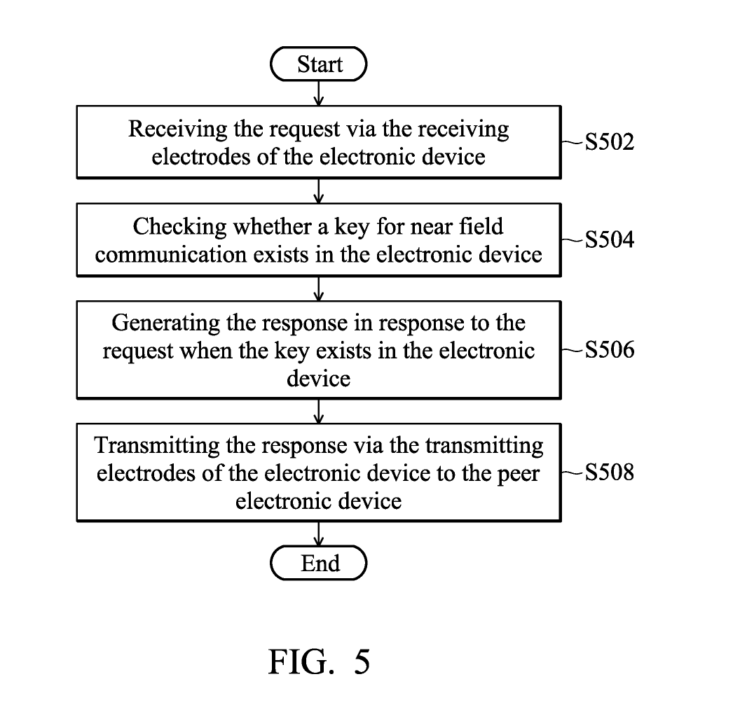

FIG. 5 shows another exemplary flow chart of a method for near field communication between two electronic devices, from the perspective of an electronic device joining the handshake procedure, according to another embodiment of the invention. First of all, the electronic device may receive the request via the receiving electrodes of the electronic device (Step S502). Next, the electronic device may check whether a key for near field communication exists (Step S504). Next, the electronic device may generate the response in response to the request when the key exists (Step S506). Next, the electronic device may transmit the response via the transmitting electrodes of the electronic device to the peer electronic device (Step S508). Here, the peer electronic device refers to the electronic device transmitting the request, and may be regarded as an external object external to the electronic device joining the handshake procedure.

Take the action of transmitting a video/audio data by using WiFi direct from the electronic device 210 to the electronic device 220 as shown in FIG. 2 as an example. The electronic device 210 may initiate a handshake procedure and invite the electronic device 220 to join the handshake procedure via the transmitting electrodes. In the handshake procedure, the electronic device 210 and the electronic device 220 may exchange essential information for establishing the WiFi direct communication link and performing the action. After exchanging the essential information, the WiFi direct communication link may be established between the electronic device 210 and the electronic device 220, and the electronic device 210 may transmit predetermined video/audio data to the electronic device 220 via the WiFi direct communication link.

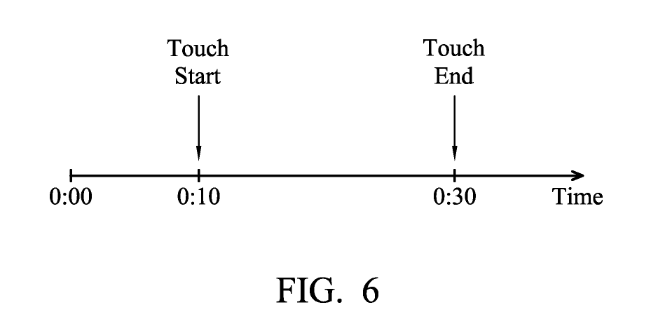

Note that in some embodiments of the invention, the video/audio data may be an extracted portion extracted from an original file, and the invention should not be limited thereto. For example, the electronic device 210 may extract a portion of data from an original video/audio file, and transmit the extracted data to the electronic device 220. FIG. 6 shows an exemplary timing diagram of video/audio data according to an embodiment of the invention. In the embodiment, when playing video/audio data, the user of the electronic device 210 may touch the screen (e.g. at the time 0:10) when the portion he/she would like to share with another user begins, and touch the screen again (e.g. at the time 0:30) when the portion he/she would like to share with another user ends. The processor of the electronic device 210 may log the start time and end time indicated by the user, extract the portion, edit the extracted portion and transmit the extracted portion to the electronic device 220 via the wireless communication link. Note that the video/audio data may be played, extracted and edited before or after the handshake procedure, and the invention should not be limited thereto.

Note that as illustrated above, the gravity sensor 140 of either electronic device may also participate in the handshake procedure and/or the action. For example, before transmitting the extracted file, the electronic device 210 may play a notify sound to ask for permission to transmit the extracted data. When hearing the notify sound, the user of the electronic device 210 may tap on the housing of the electronic device 210 using a predefined rhythm (for example, to quickly tap on the housing two times) to represent a “YES” command. Similarly, the electronic device 220 may also play a notify sound to ask for the permission to receive the data from the electronic device 210. When hearing the notify sound, the user of the electronic device 220 may tap on the housing of the electronic device 220 using a predefined rhythm to represent a “YES” or “NO” command.

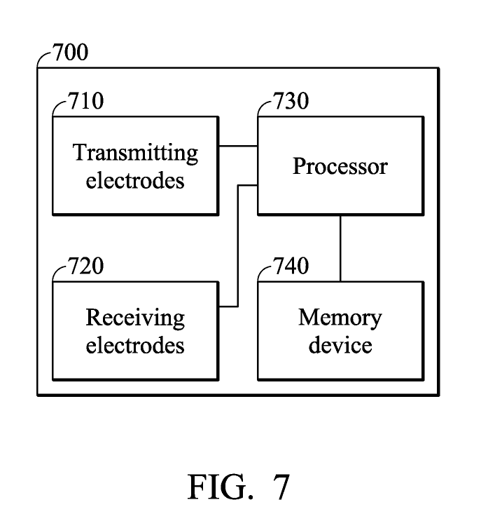

FIG. 7 shows an exemplary block diagram of another electronic device according to another embodiment of the invention. The electronic device 700 may be a dongle device, such as a USB dongle device, and may at least comprise a plurality of transmitting electrodes 710, a plurality of receiving electrodes 720, a processor 730, and a memory device 740. The transmitting electrodes 710 and receiving electrodes 720 may be implemented as the transmitting electrodes and receiving electrodes of a touch screen. The processor 730 may be coupled to the transmitting electrodes 710, the receiving electrodes 720 and the memory device 740, and may control the operations thereof. The memory device 740 may store system and user data.

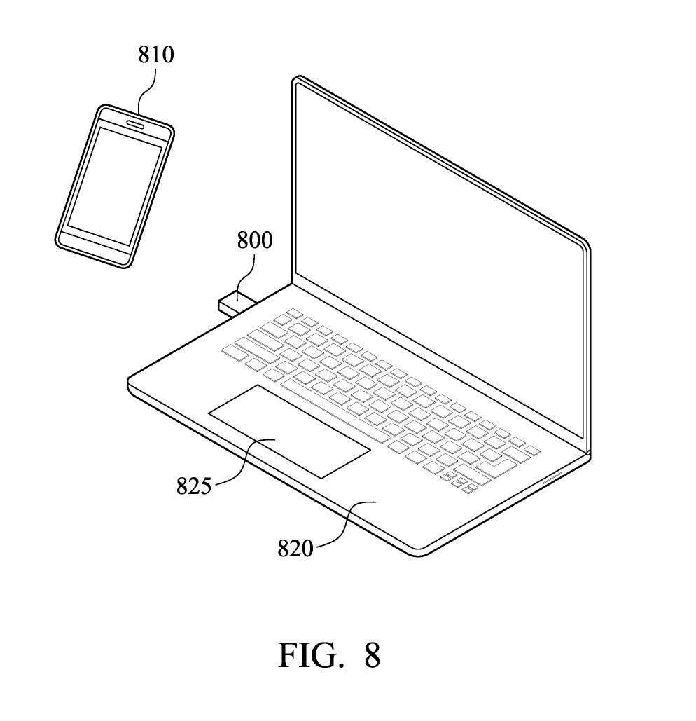

FIG. 8 is a schematic diagram showing a near field communication system according to another embodiment of the invention. The near field communication system may comprise the dongle device 800, a first electronic device 810 and a second electronic device 820 connected to the dongle device 800. For example, the dongle device 800 may be plugged into a socket of the second electronic device 820. According to an embodiment of the invention, the first electronic device 810 may be brought into physical proximity with the second electronic device 820. For example, the first electronic device 810 may be brought into contact with the mouse tracking pad 825 of the second electronic device 820, so as to generate a touch event on the mouse tracking pad 825. For another example, the mouse tracking pad 825 of the second electronic device 820 may further comprise a plurality of transmitting electrodes and receiving electrodes and may communicate with the first electronic device 810 via the transmitting electrodes and receiving electrodes thereof by transmitting and/or receiving one or more messages to and/or from the first electronic device 810. The touch event may also be generated when the mouse tracking pad 825 receiving any message from the first electronic device 810 or in response to the communication proceeded between the mouse tracking pad 825 and the first electronic device 810. Once the second electronic device 820 receives the touch event on the mouse tracking pad 825, the processor (e.g. the processor 730) of the dongle device 800 connected to the second electronic device 820 may check whether a key for near field communication exists.

When the key exists, the processor of the dongle device 800 may further generate a request and transmit the request to the first electronic device 810 via the transmitting electrodes thereof. The first electronic device 810 receiving the request may also check whether a key for near field communication exists. When the key exists, the first electronic device 810 may generate a response for responding to the request and transmit the response to the dongle device 810 or the second electronic device 820. For cases where the first electronic device 810 transmits the response to the dongle device 810, the dongle device 810 may further pass the response to the second electronic device 820 when required. Similarly, for the cases where the first electronic device 810 transmits the response to the second electronic device 820, the second electronic device 820 may further pass the response to the dongle device 810 when required. In the embodiment of the invention, the dongle device 810 may receive the response from the first electronic device 810 via the receiving electrodes.

According to the embodiments of the invention, the request and response may be transmitted in a handshake procedure for establishing a wireless communication link between the first electronic device 810 and the second electronic device 820 and further trigger the first electronic device 810 and/or the second electronic device 820 to perform an action after receiving the response. In the handshake procedure, the dongle device 810 may be utilized to facilitate the essential information for establishing the wireless communication link and essential information for preforming the action back and forth between the first electronic device 810 and the second electronic device 820. When the handshake procedure is completed, the wireless communication link may further be established between the first electronic device 810 and the second electronic device 820, and the first electronic device 810 and/or the second electronic device 820 may perform the action. According to an embodiment of the invention, the second electronic device 820 may interact with the first electronic device 810 via the wireless communication link established therebetween when performing the action, and vice versa.

In the embodiments of the invention, the action may be flexibly designed. For example, the action may be waking up the operating system of either electronic device, playing audio signals, playing video signals, turning on a camera, turning on an application program, performing a transaction, transmitting data (such as a file, a picture, a video, a song, or the likes) to another electronic device, or others. Note that in the embodiments of the invention, the action is not necessarily performed right after the handshake procedure. For example, the action may be performed at a preset time, even when the two electronic devices 810 and 820 are no longer close to each other.

In addition, in the embodiments of the invention, the key may also be flexibly designed as a software, firmware, and/or hardware value or condition of the dongle device 800 or the electronic device (e.g. the electronic device 810/820), or any combinations thereof. For example, the key may be an eFuse of the CPU, the hardware information of the electronic device, a file stored in the memory device, a gesture input by the user, the navigation or location information of the electronic device, a gravity variation or magnetic field variation of the electronic device, or others.

Note that although the first electronic device 810 is depicted as a mobile phone and the second electronic device 820 is shown as a laptop computer in FIG. 8, the invention should not be limited thereto. It is to be understood that those who are skilled in this technology can still make various alterations and modifications based on the concept illustrated in the embodiments of the invention. Note further that the key and action illustrated above are merely some examples of a variety of possible implementations, and the invention should not be limited thereto.

In some embodiments of the invention, when the electronic device 810 and/or 820 comprise a proximity sensor and/or a gravity sensor, the proximity sensor and/or the gravity sensor may also participate in the handshake procedure and/or the action as described above. For detailed illustrations of the proximity sensor and the gravity sensor, please refer to the above paragraphs, as they are omitted here for brevity.

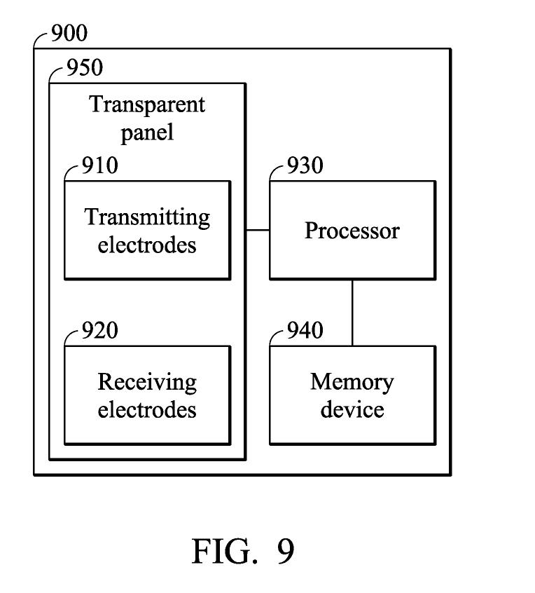

FIG. 9 shows an exemplary block diagram of another electronic device according to yet another embodiment of the invention. The electronic device 900 may at least comprise a transparent panel 950 comprising a plurality of transmitting electrodes 910 and a plurality of receiving electrodes 920, a processor 930, and a memory device 940. The transmitting electrodes 910 may be implemented as the transmitting electrodes of a touch screen. The receiving electrodes 920 may be implemented as the receiving electrodes of a touch screen. The transparent panel 950 may be implemented as a panel with or without touch-control functionality and with or without display functionality. The processor 930 may be coupled to the transparent panel 950 and the memory device 940, and may control the operations thereof. The memory device 940 may store system and user data. Note that in some embodiments of the invention, the electronic device 900 may also comprise a non-transparent panel instead of a transparent panel, and the invention should not be limited thereto.

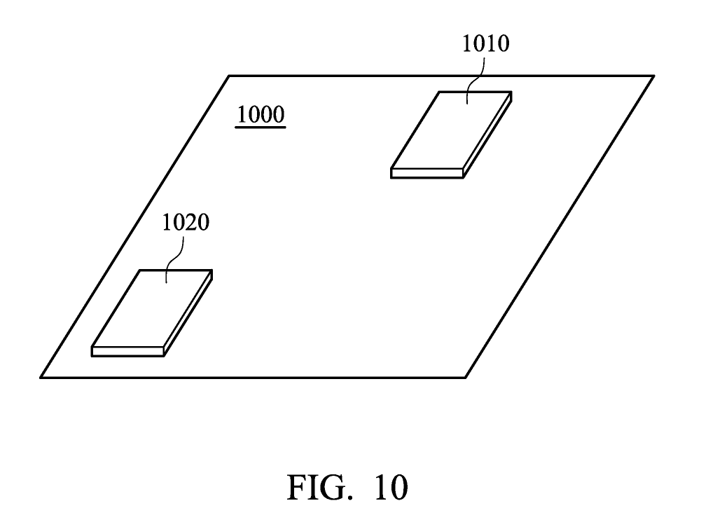

FIG. 10 is a schematic diagram showing a near field communication system according to yet another embodiment of the invention. The near field communication system may comprise the electronic devices 1000, 1010 and 1020. The electronic device 1000 may be the electronic device 900 shown in FIG. 9. The electronic devices 1010 and 1020 may be the electronic device 100 shown in FIG. 1, and may be implemented as any type of handheld electronic devices, such as a mobile phone, a tablet, or others.

According to an embodiment of the invention, since the electronic device 1000 comprises a transparent panel, the electronic device 1000 may be implemented as an exhibition window for exhibiting some products. The electronic device 1000 may simultaneously communicate with more than one electronic device approaching it, and transmit the advertisement messages of the products via the transmitting electrodes. For example, the electronic device 1000 may transmit the advertisement messages of the products to the one or more electronic devices approaching it. When the user of a electronic device would like to purchase the product, the electronic device may initiate the handshake procedure as illustrated above for exchanging essential information for establishing a wireless communication link and essential information for performing a subsequent action with the electronic device 1000. After the handshake procedure is completed, the subsequent action, such as a transaction, may further be performed as illustrated above.

Note that in the embodiments of the invention, the action is not limited to a transaction, and may be flexibly designed as illustrated above. In addition, in the embodiments of the invention, to enhance the security of performing the action, the key may be involved in the handshake procedure, and the key may also be flexibly designed as illustrated above. Note that in some embodiments of the invention, the proximity sensor and/or the gravity sensor may also participate in the handshake procedure and/or the action as described above. For detailed illustrations of the key, action, proximity sensor and gravity sensor, please refer to the above paragraphs, as they are omitted here for brevity.

According to another aspect of the invention, the electronic devices 900 and 1000 may also be implemented as an electronic device comprising only the transmitting electrodes on the transparent panel and without any receiving electrode. When the electronic devices 900 and 1000 are implemented as an electronic device comprising only transmitting electrodes on the transparent panel, the electronic device 900/1000 may keep transmitting advertisement messages via the transmitting electrodes. For example, the processor 930 may be configured to keep directing the transmitting electrodes 910 to broadcast advertisement messages. When the user holding the electronic device 1010/1020 would like to receive the advertisement messages, the user may bring the electronic device 1010/1020 into physical proximity with the transparent panel of the electronic device 1000 for receiving the advertisement messages. In such an embodiment, the electronic device 1000 may be implemented as an electronic advertisement board for broadcasting the advertisement messages. In this manner, it is more convenient and simpler for the user to get interesting information by just touching or bringing his/her electronic device close to the transparent panel of the electronic device 900/1000.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic device, comprising:
a touch screen, comprising a plurality of transmitting electrodes and a plurality of receiving electrodes configured for sensing touch events on the touch screen;
a proximity sensor, configured for sensing approach of an external object; and
a processor, coupled to the touch screen and the proximity sensor,
wherein when the proximity sensor senses a distance to the external object is under a predetermined threshold, the processor generates a request, transmits the request to the external object via the transmitting electrodes, receives a response from the external object via the receiving electrodes, and performs an action after receiving the response.

2. The electronic device as claimed in claim 1, wherein the processor transmits the request and receives the response in a handshake procedure for establishing a wireless communication link with the external object, and the processor further exchanges essential information for establishing the wireless communication link and essential information for preforming the action with the external object in the handshake procedure.

3. The electronic device as claimed in claim 2, wherein the proximity sensor keeps sensing the distance to the external object, and when the distance to the external object is not under the predetermined threshold, the processor terminates the handshake procedure.

4. The electronic device as claimed in claim 2, wherein the processor interacts with the external object via the wireless communication link when performing the action.

5. The electronic device as claimed in claim 1, wherein before generating the request, the processor further checks whether a key for near field communication exists, and the processor generates the request when the key exists.

6. The electronic device as claimed in claim 1, further comprising a gravity sensor configured for sensing and collecting gravity variation, and the gravity sensor transmits information regarding the gravity variation to the processor to facilitate the processor performing the action.

7. A near field communication method for using in an electronic device, comprising:
generating a request when sensing a distance to an external object is under a predetermined threshold;
transmitting the request via a plurality of transmitting electrodes of the electronic device to the external object;
receiving a response from the external object via a plurality of receiving electrodes of the electronic device; and
performing an action after receiving the response.

8. The near field communication method as claimed in claim 7, before the step of generating the request further comprising:
checking whether a key for near field communication exists in the electronic device.

9. The near field communication method as claimed in claim 7, wherein the steps of transmitting the request and receiving the response are performed in a handshake procedure for establishing a wireless communication link with the external object, and the method further comprises:
exchanging essential information for establishing the wireless communication link and essential information for preforming the action with the external object in the handshake procedure.

10. The near field communication method as claimed in claim 7, further comprising:
continuing sensing the distance to the external object; and
terminating the handshake procedure when the distance to the external object is not under the predetermined threshold.

11. The near field communication method as claimed in claim 9, wherein the electronic device interacts with the external object via the wireless communication link in the step of performing the action.

12. The near field communication method as claimed in claim 7, wherein the step of performing the action further comprises sensing gravity variation of the electronic device and performing the action based on the gravity variation.

13. A dongle device, comprising:
a plurality of transmitting electrodes;
a plurality of receiving electrodes; and
a processor, configured for checking whether a key for near field communication exists, generating a request when the key for near field communication exists, transmitting the request to a first electronic device via the transmitting electrodes, and receiving a response from the first electronic device via the receiving electrodes.

14. The dongle device as claimed in claim 13, wherein the processor transmits the request and receives the response in a handshake procedure for establishing a wireless communication link between the first electronic device and a second electronic device connected to the dongle device, so as to trigger the second electronic device to perform an action upon receiving the response.

15. The dongle device as claimed in claim 14, wherein the processor further transmits essential information for establishing the wireless communication link and essential information for preforming the action back and forth between the first electronic device and the second electronic device in the handshake procedure.

16. An electronic device being capable of simultaneously communicating with more than one electronic devices, comprising:
a panel, comprising a plurality of transmitting electrodes; and
a processor, configured for transmitting a plurality of advertisement messages via the transmitting electrodes.

17. The electronic device as claimed in claim 16, wherein the processor keeps directing the transmitting electrodes to transmit the advertisement messages.
